(19) United States
(12) Patent Application Publication
(10) Pub. No.: US 2006/0220535 A1
(43) Pub. Date: Oct. 5, 2006

(54) Organic electroluminescent element and display device

(75) Inventor: Masaya Nakayama, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 11/377,211

(22) Filed: Mar. 17, 2006

(30) Foreign Application Priority Data
Mar. 18, 2005 (JP) 2005-80645

(51) Int. Cl. H05B 33/00

(52) U.S. Cl. 313/504

(57) ABSTRACT

The present invention relates to an organic electroluminescent element and a display device, in which, on a substrate 1, at least an anode 2, an organic layer 3 having a luminescent layer 8, an electron injecting layer 4 and a cathode 5 are laminated in this order or in the reverse order In the organic electroluminescent element, an outer peripheral portion of the cathode 5 is positioned inside an outer peripheral portion of the electron injecting layer 4.

### CROSS-REFERENCE TO RELATED APPLICATION

This application claims priority under 35 USC 119 from Japanese Patent Application No. 2005-80645, the disclosure of which is incorporated by reference herein.

### BACKGROUND OF THE INVENTION

1. Field of the Invention

The present invention relates to an organic electroluminescent element and a display device. More particularly, the present invention relates to an organic electroluminescent element which has a characteristic configuration for preventing luminescence from edge due to an electron injecting layer, and a display device.

2. Description of the Related Art

Ever since reports have been made on a laminated organic electroluminescent element (organic EL element), in which an organic thin layer having hole transport property and an organic thin layer having electron transport property are laminated (see, for example, Applied Physics Letters, Vol. 51, p. 913, 1987), the organic electroluminescent element has attracted attention and has been intensively studied as a large-area luminescent element capable of emitting light by applying low voltages of not more than 10 V.

One reason for the success of the low voltage organic EL element is that a low work function Mg—Ag alloy having a large electron injecting capability into an organic layer is used as a cathode.

Since then, studies have been made on simple bodies of alkali metals such as Li, Na, and K, or alkaline earth metals such as Mg, Ca and Ba or alloys thereof having a low work function to be used as a cathode. However, since these metals having a low work function are easily oxidized and unstable, problems arise such as low reproducibility, low reliability and the like in performance of the EL element obtained from these simple bodies or alloys.

In order to solve these problems, it has been reported that sufficient luminescence characteristics and reliability can be obtained by using a cathode, and an electron injecting layer of a stable alkali metal compound such as Li₂O (see, for example, Japanese Patent No. 3529543). Here, a conventional organic EL element will be described with reference to FIG. 12.

FIG. 12 is a schematic cross-sectional view of a conventional organic EL element. On a transparent glass substrate 61 with an ITO anode 62 formed thereon, a hole transport layer 63, a luminescent layer 64 and an electron transport layer 65 are laminated in this order using an organic substance deposition mask (not shown). Thereafter, a Li₂O electron injecting layer 66 and a Mg—Al cathode 67 are deposited in this order using an inorganic substance deposition mask (not shown).

When a forward bias is applied by a power source 68 between the cathode 67 and the anode 62 of the organic EL element, exitons are formed in the process of recombination of electrons ejected from the electron transport layer 65 and the holes ejected from the hole transport layer 63 in the luminescent layer 64. When the excitons are dissociated, a light 69 having a wavelength according to the composition of the luminescent layer 64 is emitted.

Further, for the same purpose, it has been proposed to employ highly stable alkali halide such as LiF as the electron injecting layer (see, for example, Japanese Patent Application Laid-Open No. 2002-260862). Performance and reliability of an organic EL element are improved by the use of such a stable electron injecting layer.

However, in such an organic EL element, although an electron injecting layer is used for improving the luminance efficiency, a phenomenon of luminescence from edge is observed. For example, when an annealing treatment is performed at 80° C. for one hour, strong luminescence from an outer peripheral portion, i.e., an edge portion of the cathode is observed. The luminescence from the edge results in non-uniform luminescence on a luminescent surface.

It has also been found that the luminescence from edge, i.e., the strong luminescence from the cathode edge portion causes reduced reliability, especially considerable deterioration in brightness of the element. It is thus important to prevent the luminescence from edge in view of improving reliability of the element.

As a result of intensive study by the present inventors, it has been found that the luminescence from edge is attributed to the configuration of the edge portion of the electron injecting layer. The circumstances will be described below with reference to FIG. 13.

FIG. 13 is an enlarged view of main components of a conventional organic EL element in the vicinity of a cathode edge portion. The edge portion of an electron injecting layer 66 is tapered. When the edge portion with such a configuration is subjected to an electric energizing test or a heat treatment, an electric field concentrates on the edge portion of the electron injecting layer to emit luminescence from the edge, resulting in reduced reliability.

Such a tapered edge portion is inevitably formed when a deposition mask is used in such a manner that the electron injecting layer and the like is deposited on the deposition mask that is not closely in contact with a substrate.

### SUMMARY OF THE INVENTION

The present invention has been made in view of the above circumstances and provides an organic electroluminescent element and a display device.

A first aspect of the present invention provides an organic electroluminescent element which comprises, on a substrate, at least an anode, an organic layer having a luminescent layer, an electron injecting layer and a cathode laminated in this order or in the reverse order, wherein an outer peripheral portion of the cathode is positioned inside an outer peripheral portion of the electron injecting layer.

A second aspect of the present invention provides an organic electroluminescent element which includes, on a substrate, at least an anode, an organic layer having a luminescent layer, an electron injecting layer and a cathode laminated in this order or in the reverse order, wherein an outer peripheral portion of the cathode other than an area where a lead-out electrode is formed is positioned inside an outer peripheral portion of the electron injecting layer.

A third aspect of the present invention provides a method for producing an organic electroluminescent element, wherein the organic electroluminescent element comprises on a substrate, at least an anode, an organic layer having a luminescent layer, an electron injecting layer and a cathode laminated in this order or in the reverse order, wherein a mask for deposition used for forming the electron injecting layer has an opening area different from an opening area of a mask for deposition used for forming the cathode,

A fourth aspect of the present invention provides a display device comprising the organic electroluminescent element according to any one of the first to third aspects.

### BRIEF DESCRIPTION OF THE DRAWINGS

FIG. 1 is a view explaining a principle structure of the present invention;

FIG. 2 is a view explaining the steps until the mid-step of a manufacturing process of an organic EL element of Example 1 according to the present invention;

FIG. 3 is a view explaining the steps after the mid-step of FIG. 2 of the manufacturing process of the organic EL element of Example 1 according to the present invention;

FIG. 4 is a schematic cross-sectional view of the organic EL element in Example 1 according to the present invention;

FIG. 5 is a schematic cross-sectional view of an organic EL element according to Comparative Example;

FIG. 6 is a graph explaining change in relative brightness with lapse of time with a drive current of 15 mA/cm²;

FIG. 7 is a schematic cross-sectional view of an organic EL element in Example 2 according to the present invention;

FIG. 8 is a schematic cross-sectional view of an organic EL element in Example 3 according to the present invention;

FIG. 9 is a view explaining the steps until the mid-step of a manufacturing process of an organic EL element of Example 4 according to the present invention,

FIG. 10 is a view explaining the steps after the mid-step of FIG. 9 of the manufacturing process of the organic EL element of Example 4 according to the present invention;

FIG. 11 is a schematic cross-sectional view of a conventional organic EL element; and

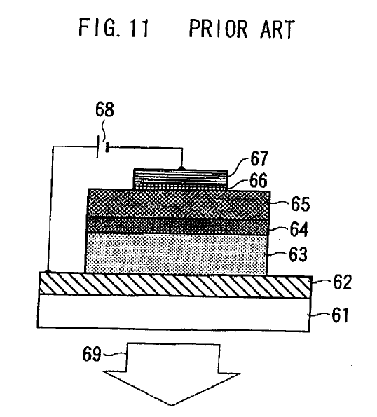

FIG. 12 is an enlarged view of main components of a conventional organic EL element in the vicinity of a cathode edge portion.

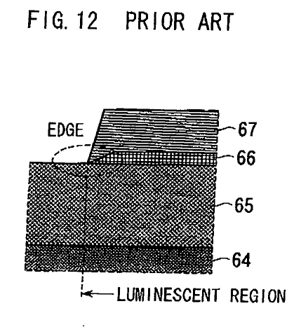

### DETAILED DESCRIPTION OF THE INVENTION

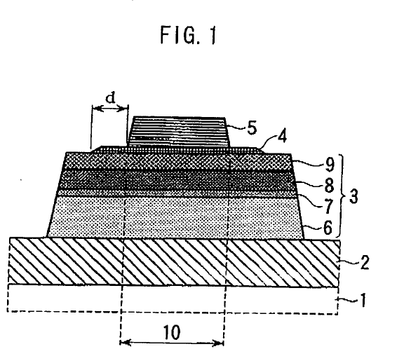

FIG. 1 is a view explaining a principle structure of the present invention. The present invention will be described below with reference to FIG. 1.

The present invention provides an organic electroluminescent element which includes, on a substrate 1, at least an anode 2, an organic layer 3 having a luminescent layer 8, an electron injecting layer 4 and a cathode 5 laminated in this order or in the reverse order. In the organic electroluminescent element, an outer peripheral portion of the cathode 5 is positioned inside an outer peripheral portion of the electron injecting layer 4.

With the configuration in which the outer peripheral portion of the cathode 5 is positioned inside the outer peripheral portion of the electron injecting layer 4, the outer peripheral portion, i.e., the edge portion, of the electron injecting layer 4 is spaced from a luminescent area 10 defined by the area of the cathode 5. Therefore, concentration of electric field on the edge portion of the electron injecting layer 4 can be prevented, and thus luminescence from the edge can be prevented.

In a case where the cathode 5 is led out of the luminescent area 10, it is only necessary to form a configuration in which the outer peripheral portion of the cathode 5 other than the area where the lead-out electrode is formed to be positioned inside the outer peripheral portion of the electron injecting layer 4.

In this case, the cathode 5 and the electron injecting layer 4 are preferably positioned such that the sum of the intervals, at both sides of the peripheral portions along a predetermined straight line, between the outer peripheral portion of the cathode 5 and the outer peripheral portion of the electron injecting layer 4, at points where the sum becomes shortest, is 20 μm or more in light of registration accuracy and deposition blur at the time of mask deposition.

The electron injecting layer 4 in this case may have a planar shape and an area identical to those of the luminescent layer 8, or may have a smaller area than that of the luminescent layer 8.

Alkali metals or alkali metal compounds having a low work function are preferably used for the electron injecting layer 4. An alkali metal fluoride which is highly chemically stable is especially preferable.

When an alkali metal fluoride is used for the electron injecting layer 4, the thickness of the layer is preferably 0.1 to 5 nm. If the thickness is 0.1 nm or less, it is difficult to maintain a proper shape as the electron injecting layer 4. If the thickness is more than 5 nm, the electric conduction therethrough cannot be properly provided because an alkali metal fluoride is an electric insulator.

Further, when an alkali metal fluoride is used for the electron injecting layer 4, a material for forming a cathode 5 is preferably Al. Al and F, which constitutes the alkali metal fluoride, react with each other to reduce the alkali metal, thereby improving the electric conduction.

The organic layer 3, including the luminescent layer 8, preferably includes at least a hole-injecting layer 6, a hole transport layer 7, a luminescent layer 8 and an electron transport layer 9. Each layer has respective functions to enhance the luminescent efficiency.

When the organic electroluminescent element is manufactured, the electron injecting layer 4 may be formed using a deposition mask having an opening area different from that of the deposition mask used at the time of forming the cathode 5. The deposition mask used for forming the electron injecting layer 4 may be either the same as, or different from the deposition mask used for forming the organic layer 3 which includes the luminescent layer 8.

Further, a display device can be obtained using the organic electroluminescent elements as pixels having the above-described configuration. Such a display device has excellent reliability and durability, without luminescence from the edge of the element.

In the present invention, an anode formed of ITO or the like, an organic layer including a hole-injecting layer, a hole transport layer, a luminescent layer and an electron transport layer, an electron injecting layer and a cathode are laminated in this order or in the reverse order on a glass substrate or the like, especially on a transparent insulating substrate.

The planar area of the electron injecting layer is set to be larger than that of the cathode. For example, an interval “d” between the outer peripheral portion of the electron injecting layer and the outer peripheral portion of the cathode is 10 μm or greater in an ideal registration state.

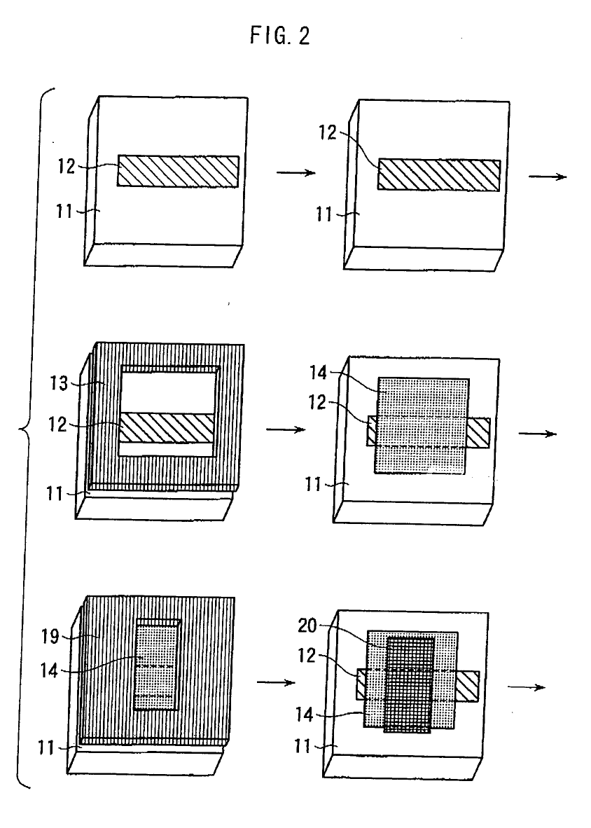

The organic EL element of Example 1 according to the present invention will be described with reference to FIG. 2 to FIG. 6. First, referring to FIG. 2 to FIG. 4, a manufacturing process of the organic EL element of Example 1 will be described.

### EXAMPLE 1

First, as shown in FIG. 2, a glass substrate 11, patterned to a predetermined shape having a thickness of, for example, 150 nm with an ITO anode 12 formed thereon is subjected to ultrasonic cleaning, and thereafter UV ozone treatment for forcible oxidization of the surface of the ITO anode 12.

Thereafter, an organic layer 14 is formed through thermal resistance heating in a vacuum apparatus using an organic layer deposition mask 13 with a predetermined opening.

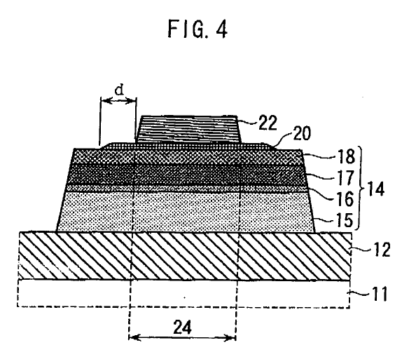

The organic layer 14 includes, as shown in FIG. 4, a hole-injecting layer 15, a hole transport layer 16, a luminescent layer 17 and an electron transport layer 18. The hole-injecting layer 15 is made of 2TNATA(4,4′,4″-tris(2-naphthylphenylamino)triphenylamine) doped with 0.1% by weight of F4-TCNQ(2,3,5,6-tetrafluoro-7,7,8,8 tetracyanoxydimethane) and has a thickness of, for example, 140 nm. The hole transport layer 16 is made of α-NPD(N,N′-dinaphthyl-N,N′-diphenyl-[1,1′-biphenyl]4,4′-diamine) and has a thickness of, for example, 10 nm. The luminescent layer 17 is formed by a host Alq3(tris(8-hydroxyquinolinate) aluminum) having a thickness of, for example, 30 nm doped with a luminescent material t(npa)py (1,3,6,8-tetraCN-(naphthyl)-N-phenylamino) pyrene. The electron transport layer 18 is made of Alq3 having a thickness of, for example, 20 nm.

Molecular structures of F4-TCNQ, 2TNATA, α-NPD, t(npa)py and Alq3 constituting the organic layer 14 are shown below

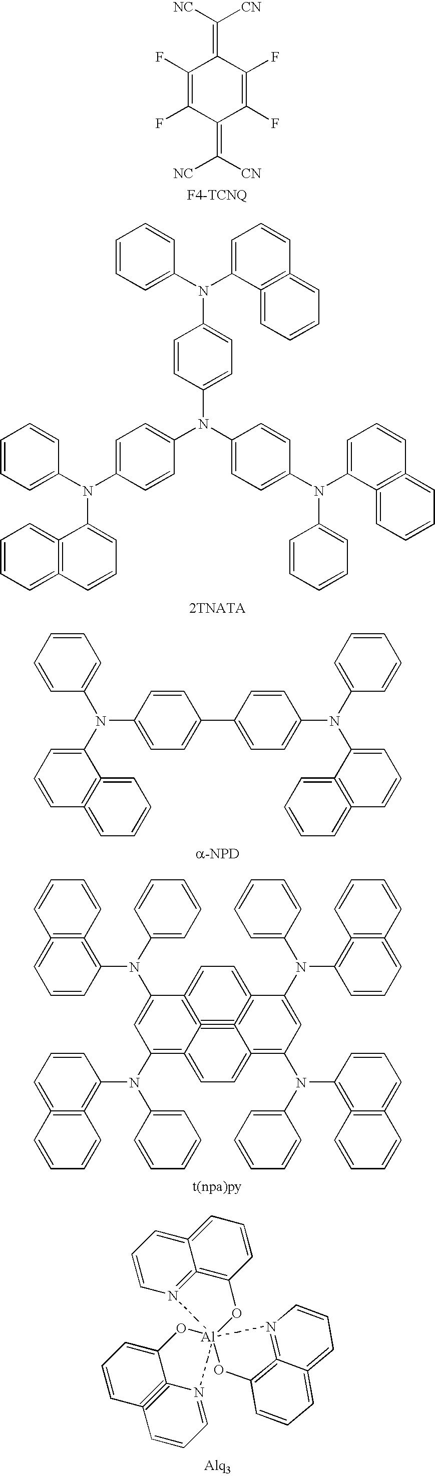

Then, using an electron injecting layer deposition mask 19 with a predetermined opening, a CsF electron injecting layer 20 with a thickness in the range of 0.1 nm to 5 nm is formed, for example, 1 nm.

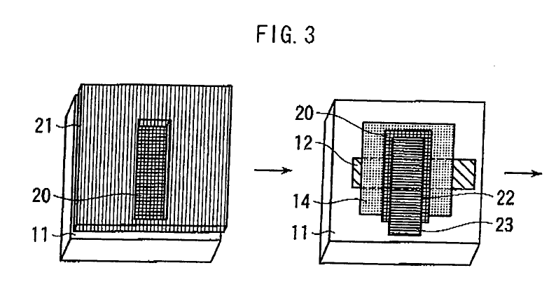

Finally, as shown in FIG. 3, an Al cathode 22 layer, having a thickness of, for example, 100 nm is formed using a cathode deposition mask 21 with a predetermined opening. Thus, a basic configuration of the organic EL element of Example 1 according to the present invention is obtained.

The cathode deposition mask 21 has an opening having an elongated and narrower shape relative to that of the opening of the electron injecting layer deposition mask 19. Thus, the outer peripheral portion of the Al cathode 22 is positioned inside the outer peripheral portion of the electron injecting layer 20, and a cathode lead-out portion 23 is formed.

The opening of the cathode deposition mask 21 is determined in light of peripheral blur and registration accuracy of the mask at the time of deposition. For example, an interval “d” between the outer peripheral portion of the Al cathode 22 and the outer peripheral portion of the electron injecting layer 20 is 10 μm or greater in an ideal registration state.

FIG. 4 is a schematic cross-sectional view of the organic EL element of Example 1 according to the present invention manufactured in the above-described manner. The formed area of the electron injecting layer 20 is larger than the formed area of the Al cathode 22.

The luminescent area 24 of the organic EL element is the area where the Al cathode 22 and the ITO anode 12 projectionally overlap with each other.

Finally, although not illustrated, as in ordinary organic EL elements, the obtained organic EL element is sealed on a glass sealing plate using a UV adhesive in a dry nitrogen atmosphere (dew-point temperature of −60° C.) to complete the organic EL element.

The initial property of the organic EL element of Example 1 is evaluated. When DC voltage of 3.0 V is applied thereto, green luminescent light of about 10 cd/m² is observed.

Further, when the organic EL element is annealed at 80° C. for one hour, a uniform luminescence is observed over the luminescent surface and no luminescence is observed at the edge of the element.

The brightness of the non-annealed organic EL element is 1334 cd/m² under a drive voltage of 6.63 V to obtain drive current of 15 mA/cm². The luminescent efficiency is 8.90 cd/A. The luminous half life period is 1000 hours. After 800 hours of driving period elapsed, no luminescence from the edge of the element is observed.

### COMPARATIVE EXAMPLE

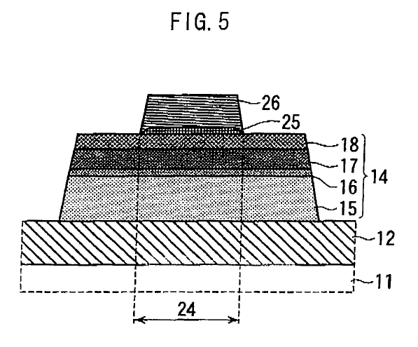

FIG. 5 is a schematic cross-sectional view of an organic EL element of a Comparative Example. A conventional organic EL element having a cathode-side structure as described in Japanese Patent No. 3529543 described above is obtained using the same material as in Example 1 and using a single deposition mask for both an electron injecting layer 25 and Al cathode 26.

The initial property of the organic EL element of the Comparative Example is evaluated. When DC voltage of 3.0 V is applied to the element, green luminescent light of about 10 cd/m² is observed as in Example 1.

However, when the conventional organic EL element is annealed at 80° C. for one hour, luminescence from the edge is observed.

The brightness of the non-annealed organic EL element is 1353 cd/m² under a drive voltage of 6.63 V to obtain a drive current of 15 mA/cm². The luminescent efficiency is 9.02 cd/A. The brightness and the luminescent efficiency are substantially equivalent to those of the organic EL element of Example 1. However, after 100 hours of drive period, the luminescence from the edge appeared and reduction in brightness becomes significant. The luminous half life period is 250 hours.

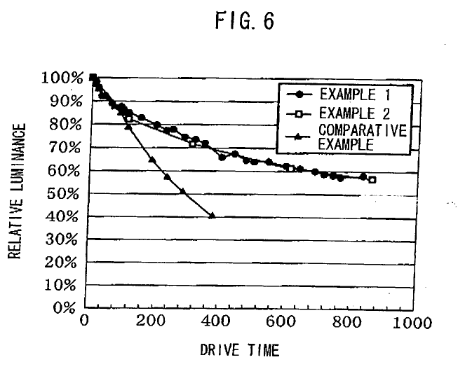

FIG. 6 is a graph explaining change in the relative brightness with a drive current of 15 mA/cm² with lapse of time. FIG. 6 shows that the luminous half life period is 250 hours in Comparative Example, but in Example 1, it is 1000 hours which is obtained by extrapolating the tendency of the graph.

In Example 1, the planar area of the electron injecting layer is larger than that of the cathode, such that the edge portion of the electron injecting layer does not overlap with the luminescent area. As a result, no luminescence from the edge is caused and reduction in brightness can be significantly suppressed.

### EXAMPLE 2

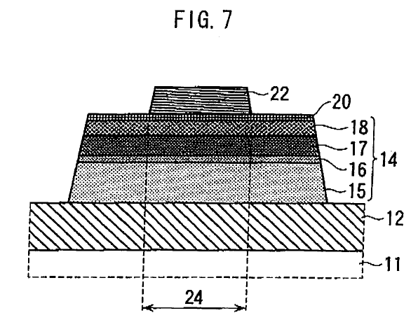

Next, an organic EL element of Example 2 of the present invention will be described with reference to FIG. 7.

FIG. 7 is a schematic cross-sectional view of the organic EL element in Example 2. The basic configuration of the organic EL element of Example 2 is similar to that of Example 1 except that, at the time of the deposition step for forming the electron injecting layer 20, the same organic layer deposition mask used in depositing the organic layer 14 is used.

The initial property of the organic EL element of Example 2 is evaluated. When DC voltage of 3.0 V is applied, green luminescence of about 10 cd/m² is observed as in Example 1.

Further, when the organic EL element is annealed at 80° C. for one hour, a uniform luminescence is observed over the luminescent surface and no luminescence is observed at the edge of the element.

The brightness of the non-annealed organic EL element is 1353 cd/m² under a drive voltage of 6.51 V to obtain drive current of 15 mA/cm². The luminescent efficiency is 9.02 cd/A. The luminous half life period is 1000 hours, which is substantially the same as that of the organic EL element of Example 1.

The change in the relative brightness of the organic EL element of Example 2 with passage of time is also shown in FIG. 6.

In Example 2, there is no need to use a deposition mask specifically designed for forming the electron injecting layer, and therefore time can be saved for changing the masks.

However, the organic layer deposition mask requires careful cleaning during the cleaning process since organic and inorganic substances adhere thereto.

### EXAMPLE 3

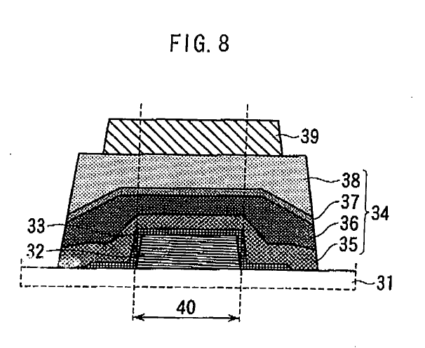

Next, an organic EL element of Example 3 of the present invention will be described with reference to FIG. 8. The organic EL element of Example 3 is manufactured in the same manner as Example 1 except that the step of forming the electron injecting side layer and the step of forming the hole injecting side layer are reversed in order.

FIG. 8 is a schematic cross-sectional view of the organic EL element in Example 3 according to the present invention. In a vacuum apparatus, an Al cathode 32 having a thickness of, for example, 100 nm is formed on a glass substrate 31 using a cathode deposition mask having an opening. Then, a CsF electron injecting layer 33 having a thickness in the range of 0.1 nm to 5 nm, for example, 1 nm is formed using an electron injecting layer deposition mask having an opening larger than that of the cathode deposition mask.

Subsequently, an organic layer 34 and an ITO anode 39 having a thickness of 150 nm are formed in this order through thermal resistance heating using deposition mask for an organic layer with an opening larger than that of the electron injecting layer deposition mask.

The organic layer 34 includes an electron transport layer 35, a luminescent layer 36, a hole transport layer 37 and a hole-injecting layer 38. The electron transport layer 35 is made of Alq3 having a thickness of 20 nm. The luminescent layer 36 is formed by a host Alq3 having a thickness of 30 nm doped with 1% by weight of a luminescent material t(npa)py. The hole transport layer 37 is made of α-NPD having a thickness of 10 nm. The hole-injecting layer 38 is made of 2TNATA having a thickness of 140 nm.

Finally, the obtained organic EL element is sealed on a glass sealing plate using a UV adhesive in a dry nitrogen atmosphere (dew-point temperature of −60° C.) to complete the organic EL element of Example 3.

As described above, the edge portion of the electron injecting layer is tapered also in Example 3, but the edge portion does not overlap with the luminescent area, and thus no luminescence from the edge is caused.

In Example 3 of the present invention, the luminescence is led from the anode side at the topmost layer of the formed layers. Therefore, it is not necessary to employ a transparent substrate as a substrate. The layers may be directly deposited on a base material of interior decoration.

If the base material is an electrically conductive member, the surface of the base material may be insulated with an SiO₂ layer and the like.

### EXAMPLE 4

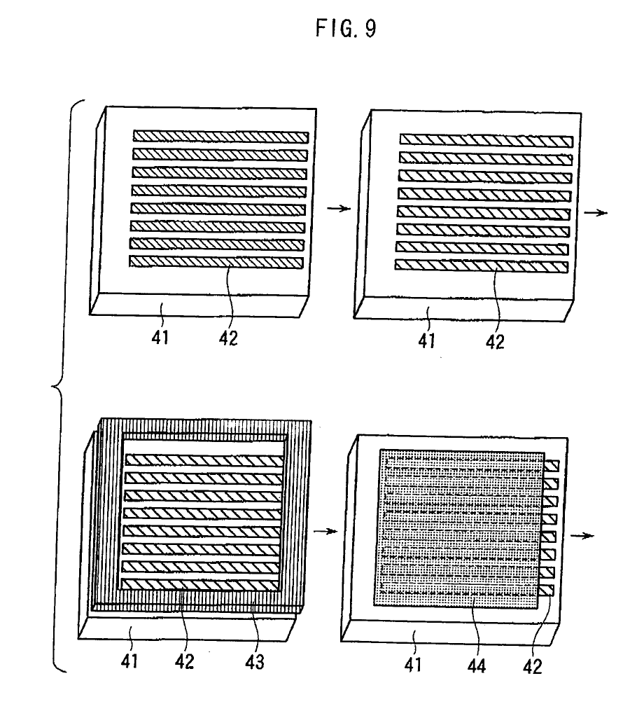

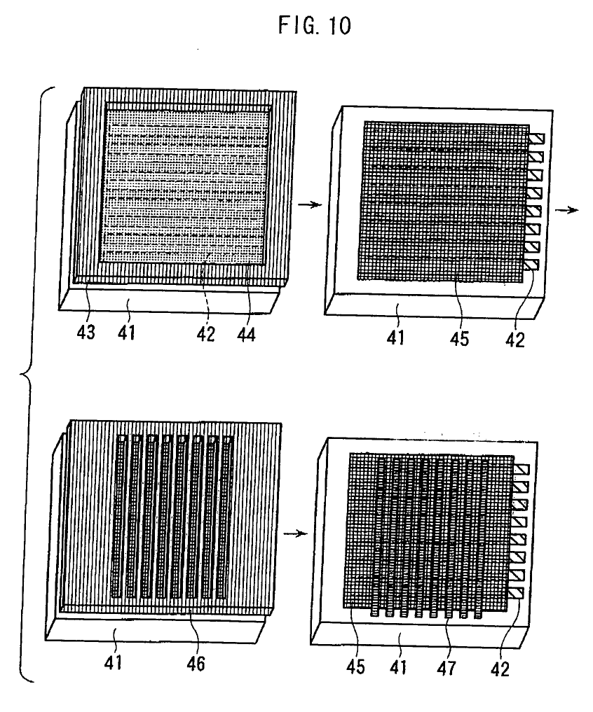

Next, an organic EL display device of Example 4 of the present invention will be described with reference to FIG. 9 and FIG. 10. The process is substantially the same as that of Example 2 except that pixels formed of organic EL elements are formed in a two-dimensional matrix in place of a single organic EL element.

First, as shown in FIG. 9, a glass substrate 41 patterned to a predetermined shape having a thickness of, for example, 150 nm with a strip-shaped ITO anode 42 formed thereon is subjected to ultrasonic cleaning, and thereafter UV ozone treatment for forcible oxidization of the surface of the ITO anode 42.

The ITO anode includes eight strips herein for simplicity in explanation.

Then, an organic layer 44 is formed by thermal resistance heating in a vacuum apparatus using a deposition mask 43 with a predetermined opening for an organic layer.

The organic layer 44 includes, as in Example 2, a layer configuration of a hole-injecting layer, a hole transport layer, a luminescent layer and an electron transport layer laminated in this order. The hole-injecting layer is made of 2TNATA doped with 0.1% by weight of F4-TCNQ and has a thickness of 140 nm. The hole transport layer is made of α-NPD having a thickness of, for example, 10 nm. The luminescent layer is formed by a host Alq3 having a thickness of, for example, 30 nm doped with a luminescent material t(npa)py. The electron transport layer is made of Alq3 having a thickness of, for example, 20 nm.

Thereafter, as shown in FIG. 10, a CsF electron injecting layer 45 having a thickness of 0.1 nm to 5 nm, for example, 1 nm is formed using the same organic layer deposition mask 43.

Finally, an Al cathode 47, having a thickness of for example, 100 nm is formed using a cathode deposition mask 46 with a predetermined opening. Thus, a basic configuration of the organic EL element is obtained.

The ITO anode includes eight strips herein for simplicity in explanation.

Finally, although not illustrated, as in ordinary organic EL display devices, the obtained organic EL element is sealed on a glass sealing plate using a UV adhesive in a dry nitrogen atmosphere (dew-point temperature of −100° C.) to complete a monochrome passive matrix type organic EL display device of Example 4 of the present invention.

In the organic EL display device of Example 4, because the Al cathode of each pixel does not protrude from the electron injecting layer, no luminescence is caused at the edge portion of the Al cathode, and thus reduction in brightness can be significantly suppressed.

Examples of the present invention have been described, but the present invention is not limited to the described conditions and configurations. Various modifications can be made to the present invention. For example, the green luminescent element is described in the Examples, but the present invention is not limited thereto. Rather, according to colors of luminescent light, the materials of the organic layer may be appropriately selected from known organic EL materials.

In the Examples, the CsF electron injecting layer is described, but the present invention is not limited thereto. Any alkali metal fluoride such as LiF, NaF, KF, RbF which are similar to CsF may be employed.

The present invention is not limited to alkali metal fluoride, but, alkali metal halide such as LiCl, LiBr, LiI, NaCl, NaBr, NaI, KCl, KBr, KI, RbCl, RbBr, RbI, CsCl, CsBr, CsI may also be used.

Alternatively, alkali metal compounds which include alkali metal oxide such as Li₂O, Na₂O, K₂O, Rb₂O, Cs₂O and the like, alkali metal salt such as Li₂CO₃, Na₂CO_{3, K}₂CO₃, Rb₂CO₃, Cs₂CO₃, and the like may also be used for the electron injecting layer.

Further, alkali metal itself including Li, Na, K, Rb, Cs may be used for the electron injecting layer, but the above-described alkali metal fluoride is particularly preferable in view of stability.

Al cathode was used in the Examples, but the present invention is not limited thereto. Other metals such as Ag, Au and Mo may also be used.

However, in a case where the electron injecting layer is made of alkali metal fluoride, an Al cathode is particularly preferable.

In particular, when the electron injecting layer is formed of alkali metal fluoride and an Al is used for a cathode, Al and F react with each other to reduce alkali metal constituting the alkali metal fluoride, although the alkali metal fluoride is an electric insulator. Thus, electric conduction via the alkali metal becomes possible.

Further, the sealed environment is a dry nitrogen atmosphere (dew-point temperature of −60° C.) in Examples 1 to 3, and is a dry nitrogen atmosphere (dew-point temperature of −100° C.) in Example 4. The difference arises from the performance of the manufacturing apparatus used, and in each case, drier nitrogen atmosphere is generally preferable.

Although a monochrome display device is described in Example 4, the present invention may also be applied to a full-color display device by combining red and blue luminescent elements in addition to the green luminescent element.

A passive-matrix display device using a simple matrix is described in Example 4; however, the present invention is not limited thereto. The present invention may be applied to an active-matrix display device using active elements such as a TFT.

In the Examples, the anode electrode is transparent and light is led therefrom. However, the cathode electrode may be translucent or transparent and light may be led from the cathode side. In the latter case, the anode may be a reflective electrode to improve light-leading efficiency.

In this case, except for Example 2, conductive materials such as stainless steel, insulator materials, or opaque materials may be used as a substrate. When a translucent or transparent electrode is used as a cathode, any substrate may be used.

The present invention provides an organic EL element having a relaxed concentration of electric field on the edge portion of the electron injecting layer to prevent the luminescence therefrom. In the present invention, the formed area of the electron injecting layer of the organic EL element is larger than the formed area of the cathode. Therefore, the edge portion of the electron injecting layer is not included in the luminescent area of the organic EL element. Accordingly, luminescence from the edge of the element can be prevented, and reduction in brightness can be suppressed. As a result, a highly reliable organic EL element or organic EL display device can be realized.

Although the present invention is typically applied to a two-dimensional matrix display device, the present invention is not limited to display devices. The present invention can be applied to a large single light source such as a light source for mood lighting.

The present invention includes the following embodiments:

1. An organic electroluminescent element which comprises, on a substrate 1, at least an anode 2, an organic layer 3 having a luminescent layer 8, an electron injecting layer 4 and a cathode 5 laminated in this order or in the reverse order, wherein an outer peripheral portion of the cathode is positioned inside an outer peripheral portion of the electron injecting layer.

2. An organic electroluminescent element which includes, on a substrate 1, at least an anode 2, an organic layer 3 having a luminescent layer 8, an electron injecting layer 4 and a cathode 5 laminated in this order or in the reverse order, wherein an outer peripheral portion of the cathode 5 other than an area where a lead-out electrode is formed is positioned inside an outer peripheral portion of the electron injecting layer 4.

3. An organic electroluminescent element according to 1 or 2, wherein the cathode 5 and the electron injecting layer 4 are positioned such that the sum of the intervals, at both sides of the peripheral portions along a predetermined straight line, between the outer peripheral portion of the cathode 5 and the outer peripheral portion of the electron injecting layer 4, at points where the sum becomes shortest, is 20 μm or more.

4. An organic electroluminescent element according to any one of 1 to 3, wherein the electron injecting layer 4 has a planar shape and an area identical to those of the luminescent layer 8.

5. An organic electroluminescent element according to any one of 1 to 3, wherein the electron injecting layer 4 has an area smaller than that of the luminescent layer 8.

6. An organic electroluminescent element according to 1 or 2, wherein the electron injecting layer 4 comprises alkali metal or an alkali metal compound.

7. An organic electroluminescent element according to 6, wherein the electron injecting layer 4 comprises an alkali metal fluoride.

8. An organic electroluminescent element according to 7, wherein the electron injecting layer 4 has a layer thickness of from 0.1 to 5 nm.

9. An organic electroluminescent element according to 7 or 8, wherein the cathode contains aluminum.

10. An organic electroluminescent element according to any one of 1 to 9, wherein the organic layer 3 having the luminescent layer 8, comprises at least a hole injecting layer 6, a hole transport layer 7, a luminescent layer 8 and an electron transport layer 9.

11. A method for producing an organic electroluminescent element, wherein the organic electroluminescent element comprises on a substrate, at least an anode 2, an organic layer 3 having a luminescent layer 8, an electron injecting layer 4 and a cathode 5 laminated in this order or in the reverse order, wherein a mask for deposition used for forming the electron injecting layer 4 has an opening area different from an opening area of a mask for deposition used for forming the cathode 5.

12. A method for producing an organic electroluminescent element according to 11, wherein the mask for deposition used for forming the electron injecting layer 4 is different from a mask for deposition used for forming the organic layer 3 including the luminescent layer 8.

13. A method for producing an organic electroluminescent element according to 11, wherein the electron injecting layer 4 is formed by the use of the same mask as that for forming the organic layer 3 including the luminescent layer 8.

14. A display device comprising the organic electroluminescent element according to any one of 1 to 10.

What is claimed is:

1. An organic electroluminescent element which comprises, on a substrate, at least an anode, an organic layer having a luminescent layer, an electron injecting layer and a cathode laminated in this order or in the reverse order, wherein an outer peripheral portion of the cathode is positioned inside an outer peripheral portion of the electron injecting layer.

2. An organic electroluminescent element which includes, on a substrate, at least an anode, an organic layer having a luminescent layer, an electron injecting layer and a cathode laminated in this order or in the reverse order, wherein an outer peripheral portion of the cathode other than an area where a lead-out electrode is formed is positioned inside an outer peripheral portion of the electron injecting layer.

3. An organic electroluminescent element according to claim 1, wherein the cathode and the electron injecting layer are positioned such that the sum of the intervals, at both sides of the peripheral portions along a predetermined straight line between the outer peripheral portion of the cathode and the outer peripheral portion of the electron injecting layer, at points where the sum becomes shortest, is 20 μm or more.

4. An organic electroluminescent element according to claim 1, wherein the electron injecting layer has a planar shape and an area identical to those of the luminescent layer.

5. An organic electroluminescent element according to claim 1, wherein the electron injecting layer has an area smaller than that of the luminescent layer.

6. An organic electroluminescent element according to claim 1, wherein the electron injecting layer comprises alkali metal or an alkali metal compound.

7. An organic electroluminescent element according to claim 6, wherein the electron injecting layer comprises an alkali metal fluoride.

8. An organic electroluminescent element according to claim 7, wherein the electron injecting layer has a layer thickness of from 0.1 to 5 nm.

9. An organic electroluminescent element according to claim 7, wherein the cathode contains aluminum.

10. An organic electroluminescent element according to claim 1, wherein the organic layer comprises at least a hole-injecting layer, a hole transport layer, the luminescent layer and an electron transport layer.

11. A method for producing an organic electroluminescent element, wherein the organic electroluminescent element comprises on a substrate, at least an anode, an organic layer having a luminescent layer, an electron injecting layer and a cathode laminated in this order or in the reverse order, wherein a mask for deposition used for forming the electron injecting layer has an opening area different from an opening area of a mask for deposition used for forming the cathode.

12. A method for producing an organic electroluminescent element according to claim 11, wherein the mask for deposition used for forming the electron injecting layer is different from a mask for deposition used for forming the organic layer including the luminescent layer.

13. A method for producing an organic electroluminescent element according to claim 11, wherein the electron injecting layer is formed by the use of the same mask as that for forming the organic layer including the luminescent layer.

14. A display device comprising the organic electroluminescent element according to claim 1.

15. A display device comprising the organic electroluminescent element according to claim 2.

16. A display device comprising the organic electroluminescent element according to claim 3.

17. A display device comprising the organic electroluminescent element according to claim 4.

18. A display device comprising the organic electroluminescent element according to claim 5.

19. A display device comprising the organic electroluminescent element according to claim 6.

20. A display device comprising the organic electroluminescent element according to claim 7.
